(19) United States
(12) Patent Application Publication
(10) Pub. No.: US 2016/0329949 A1
(43) Pub. Date: Nov. 10, 2016

(54) APPARATUS AND METHODS FOR SCALABLE RECEIVERS

(71) Applicant: ANALOG DEVICES GLOBAL, Hamilton (BM)

(72) Inventors: Mark Cloutier, Gatineau (CA); Dragoslav Culum, Ottawa (CA)

(21) Appl. No.: 14/919,590

(22) Filed: Oct. 21, 2015

Related U.S. Application Data
(60) Provisional application No. 62/157,259, filed on May 5, 2015.

(51) Int. Cl. H04B 7/08

(52) U.S. Cl. CPC H04B 7/0885

(57) ABSTRACT

Apparatus and methods for scalable receivers are provided herein. In certain implementations, a scalable receiver system includes at least one analog-to-digital converter (ADC) that receives coded analog outputs from two or more receiver front ends. The receiver front ends system can process and code analog signals received from antennas using track and hold circuitry and various other circuitry such as filters and mixers.

### CROSS-REFERENCE TO RELATED APPLICATIONS

The present application claims priority to U.S. Provisional Patent Application No. 62/157,259, filed May 5, 2015, and titled “APPARATUS AND METHODS FOR SCALABLE RECEIVERS,” the entirety of which is hereby incorporated herein by reference.

### BACKGROUND

1. Field

Embodiments of the invention relate to electronic systems, and more particularly, to radio frequency electronics.

2. Description of the Related Technology

Certain radio frequency (RF) communication systems, such as receiver or transceiver systems, can include analog-to-digital converters (ADCs) for converting analog receive signals into digital data. For example, the RF communication system can include a demodulator for demodulating a signal received from a transmitter to generate in-phase (I) and quadrature-phase (Q) receive signals. Additionally, the ADCs can be used to convert the I and Q receive signals into digital data, which can be further processed by digital processing circuitry.

### SUMMARY

In one aspect, an apparatus includes a plurality of receiver channels including a first receiver channel and a second receiver channel. The first receiver channel is configured to receive a first analog receive signal, and includes a first receiver front end configured to generate a first coded analog signal based on coding the first analog receive signal with a first code signal. The second receiver channel is configured to receive a second analog receive signal, and includes a second receiver front end configured to generate a second coded analog signal based on coding the second analog receive signal with a second code signal. The apparatus further includes an analog-to-digital converter (ADC) configured to combine at least the first and second coded analog signals to generate a digital output signal.

In another aspect, an apparatus includes a plurality of antennas including a first antenna and a second antenna, a plurality of receiver front ends including a first receiver front end and a second receiver front end, and an ADC. The first receiver front end includes an input electrically connected to the first antenna and an output that generates a first coded analog signal. The first receiver front end further includes a first track and hold circuit electrically connected in a signal path between the input and the output of the first receiver front end. The second receiver front end includes an input electrically connected to the second antenna and an output that generates a second coded analog signal. The second receiver front end further includes a second track and hold circuit electrically connected in a signal path between the input and the output of the second receiver front end. The ADC is configured to combine a plurality of coded analog signals including the first coded analog signal and the second coded analog signal.

In another aspect, a method of radio frequency communication is provided. The method includes receiving a first analog receive signal from a first antenna, generating a first coded analog signal based on coding the first analog receive signal with a first code signal using a first receiver front end, receiving a second analog receive signal from a second antenna, generating a second coded analog signal based on coding the second analog receive signal with a second code signal using a second receiver front end, generating a combined analog signal based on combining at least the first and second analog receive signals, and converting the combined analog signal to a digital output signal using a shared ADC.

### BRIEF DESCRIPTION OF THE DRAWINGS

FIG. 1 is a schematic diagram of one example of a 4G diversity receiver.

FIG. 2 is a schematic diagram of one example of an array of 4G diversity receivers scaled for 5G.

FIG. 3 is a schematic diagram of one embodiment of a scalable receiver.

FIG. 4 is a schematic diagram of another embodiment of a scalable receiver.

FIG. 5 is a schematic diagram of another embodiment of a scalable receiver.

FIG. 6 is a schematic diagram of another embodiment of a scalable receiver.

FIG. 7 is a schematic diagram of another embodiment of a scalable receiver.

### DETAILED DESCRIPTION OF EMBODIMENTS

The following detailed description of embodiments presents various descriptions of specific embodiments of the invention. However, the invention can be embodied in a multitude of different ways as defined and covered by the claims. In this description, reference is made to the drawings in which like reference numerals indicate identical or functionally similar elements.

To increase data rates in radio frequency (RF) communication systems, fifth generation mobile communication systems (for example, 4.5G and 5G) can be implemented using massive multiple-input-multiple-output (MIMO) architectures having a relatively large number of parallel RF transceivers that simultaneously process multiple RF bands.

In addition, to increase data rates, an RF communication system can operate using carrier aggregation, in which the RF communication system communicates based on transmitting or receiving RF signals across multiple carriers. Thus, multiple carriers are aggregated to increase the RF communication system's bandwidth. Carrier aggregation includes both contiguous carrier aggregation in which the carriers are adjacent in frequency to one another, and non-contiguous carrier aggregation in which the carriers are separated in frequency from one another, such as when the carriers are in different frequency bands.

Carrier aggregation can be combined with parallel transceiver architectures to increase data rates.

However, increasing data rates by massive parallelization of transceivers can dramatically increase hardware costs and/or power consumption. Existing transceiver architectures are unsuitable for scaling to meet demands for higher data rates, including, for example, data rates for 4.5G and/or 5G.

For example, a parallel transceiver system can include an array of RF receivers each including a data converter and a digital signal processor (DSP). The data converter of a particular RF receiver can generate a digital representation of a signal received by the receiver, and the DSP can process the digital representation of the received signal. The processed outputs of the DSPs of the array can be combined to generate a wideband signal in non-contiguous or contiguous carrier aggregation applications and/or to combine data from each RF receiver. However, providing wide bandwidth using a large number of high speed data converters can increase power consumption and/or hardware costs. Moreover, providing wide bandwidth in this manner can introduce complexities associated with clock distribution and/or data processing.

Apparatus and methods for scalable receivers are provided herein. In certain configurations, an RF communication system includes a plurality of RF front ends that each generate an analog receive signal. The RF communication system combines the analog receive signals to generate a combined analog receive signal that is converted using a shared data converter.

For example, in one embodiment, an RF communication system includes a shared analog-to-digital converter (ADC) and two or more receiver channels including a first receiver channel and a second receiver channel. The first receiver channel receives a first analog receive signal and includes a first RF front end that generates a first coded analog signal based on coding the first analog receive signal with a first code signal. Additionally, the second receiver channel receives a second analog receive signal and includes a second RF front end that generates a second coded analog signal based on coding the second analog receive signal with a second code signal. The shared ADC combines at least the first and second coded analog signals to generate a digital output signal, which can be decoded using anticodes to recover digital representations of the first and second receive signals.

Configuring the RF communication system in this manner can provide wide bandwidth with relatively low power consumption and/or hardware costs. Additionally, the RF communication system can have enhanced flexibility and/or reduced complexity. For example, the RF communication system can have fewer complexities associated with clock distribution and/or data processing relative to an RF communication system implemented using massive parallelization of data converters and DSPs.

In certain implementations, the combined analog signal is processed using a single shared ADC. In other implementations, the RF communication system includes quadrature receivers that separately process in-phase (I) and quadrature-phase (Q) signals, and the RF communication system includes a first shared ADC for quantizing a combined I signal and a second shared ADC for quantizing a combined Q signal.

The plurality of RF front ends can receive signals from a plurality of antenna elements. In certain configurations, the individual signals from each antenna element in the array are encoded using mixers prior to combining After combining the signals, the combined signal is quantized and later separated in a DSP or other signal recovery circuitry.

In certain configurations, the receiver channels each include track and hold circuitry used to track and hold an analog receive signal received by a particular receiver channel. Including track and hold circuitry can enhance the ability of the RF communication system to separate the shared converter's digital output signal into separate digital signals associated with each receiver channel. For example, sampling and holding an analog receive signal for an amount of time greater than or equal to a code signal's duration can provide substantially perfect code separation.

The teachings herein can be used to support massive MIMO and multi-band 4.5G and/or 5G RF architectures with a shared data converter. Thus, the teachings herein can provide 4.5G and/or 5G scalability with low power and/or low cost.

### Overview of 4G Diversity Receivers

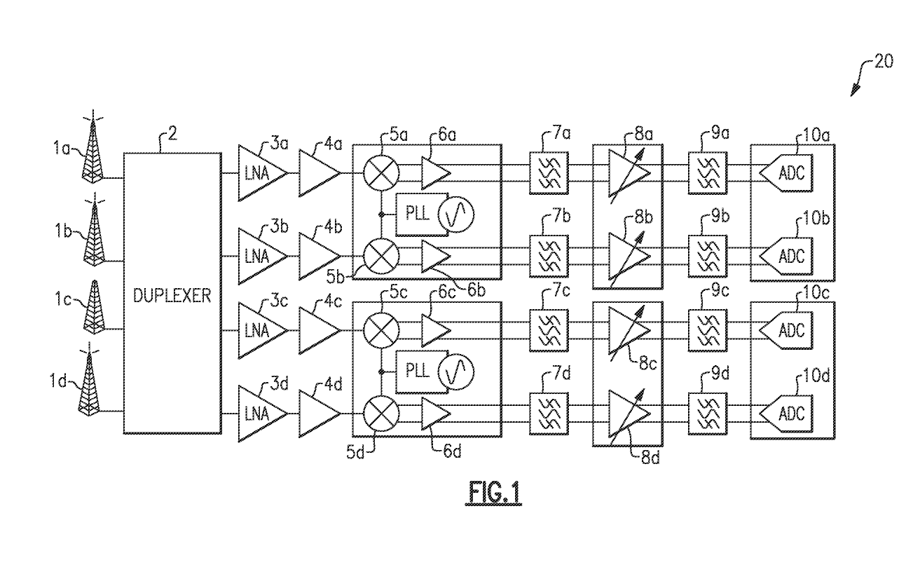

FIG. 1 is a schematic diagram of one example of a 4G diversity receiver 20. The diversity receiver 20 includes antennas 1a-1d, duplexer 2, low noise amplifiers (LNAs) 3a-3d, gain elements 4a-4d, mixers 5a-5d, amplifiers 6a-6d, bandpass filters 7a-7d, programmable gain amplifiers (PGAs) 8a-8d, bandpass filters 9a-9d, and ADCs 10a-10d.

Although the diversity receiver 20 is illustrated as including four receive paths, the receiver can be modified to include more or fewer receive paths.

As shown in FIG. 1, the diversity receiver 20 includes one complete receiver per antenna, and each of the receive paths includes a separate ADC.

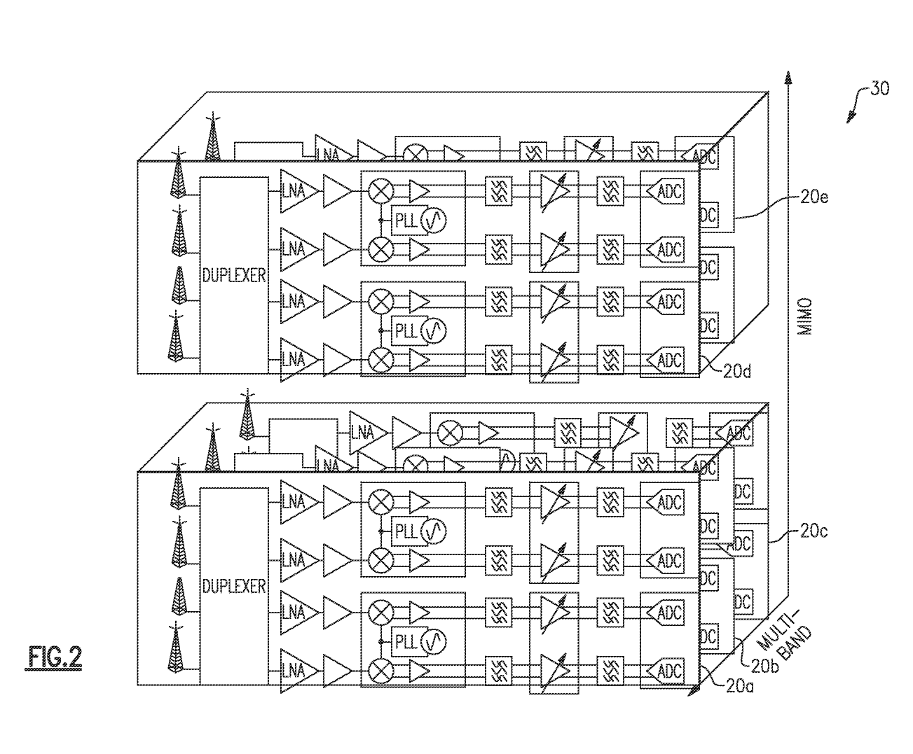

FIG. 2 is a schematic diagram of one example of an array 30 of the 4G diversity receivers 20 of FIG. 1. The array 30 includes both diversity receivers used for multi-band communications (for example, carrier aggregation) as well as diversity receivers used for multiple-input and multiple-output (MIMO) communications. Although five diversity receivers 20a-20e are illustrated in FIG. 2, the array 30 can include a larger number of diversity receivers. The array 30 illustrates an example of scaling a 4G diversity receiver for 5G applications.

The array 30 includes multiple receivers that operate in parallel on RF signals received over multiple antennas. Although including multiple receivers can increase bandwidth, arraying multiple receivers in this manner can increase hardware cost and/or power consumption.

In certain implementations, the diversity receivers 20a-20e include ADCs implemented as wideband ADCs. For example, including a wideband ADC in a diversity receiver can aid in meeting performance specifications associated with a particular communication standard and/or in providing coverage over a larger number of frequency bands. Although including a wideband ADC in a diversity receiver provides certain performance benefits, a wideband ADC also consumes more power than a narrowband ADC.

Although the illustrated array 30 of diversity receivers can have a relatively high bandwidth, the array 30 can also have a relatively high cost, complexity, and/or power consumption, particularly in configurations in which the ADCs are implemented as wideband ADCs. The increase in cost, complexity, and/or power consumption can rapidly increase as the array is scaled to provide operation over additional frequency bands.

### Overview of Scalable Receiver Systems

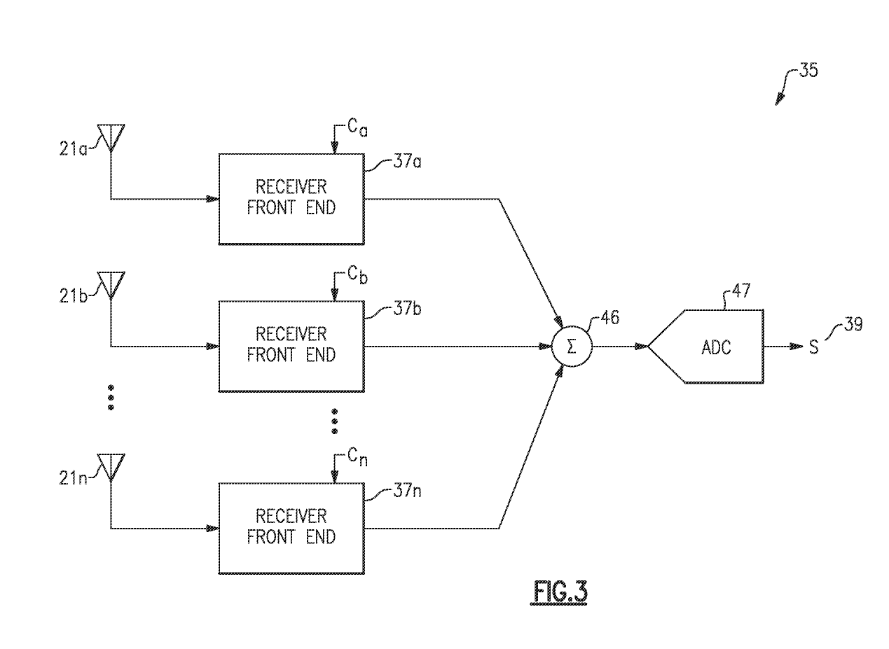

FIG. 3 is a schematic diagram of one embodiment of a scalable receiver 35. The scalable receiver 35 includes antennas 21a-21n, receiver front ends 37a-37n, an adder 46, and a shared analog-to-digital converter (ADC) 47. The scalable receiver 40 can be used to provide scalability for 4.5G and/or 5G communications, including for MIMO and/or multi-band configurations. However, the scalable receiver 35 can also be used for other communications and/or applications.

Although illustrated for the case of processing n=3 RF signals, the receiver 35 can be scaled to process additional RF signals. In one embodiment n is selected to be in the range of 2 to 64 RF signals received from antenna elements. Many other array sizes are possible with the scalable technique in both single and multi-band configurations.

In the illustrated embodiment, the receiver front ends 37a, 37b, 37n are used to process RF signals received over the antennas 21a, 21b, 21n. A receiver front end can also be referred to as an RF front end. An RF front end can include a variety of RF circuitry. The RF circuitry can be used to process an RF signal for further signal decoding and/or processing. The RF circuitry can include LNAs, mixers, filters, data converters, local oscillators, or other suitable circuits that can be used to process an RF signal received from an antenna.

The illustrated receiver front ends 37a, 37b, 37n also receive code signals Ca, Cb, Cn, respectively. The code signals Ca, Cb, Cn can be used by RF circuitry of the receiver front ends 37a, 37b, 37n to encode output signals generated by the front ends. In one example, the code signal Ca can be mixed with a local oscillator signal in receiver front end 37a to generate an analog coded receive signal.

In certain configurations, the code signals Ca, Cb, Cn can each represent a different binary sequence of 1s and 0s, where a “1” is represented by a first voltage level and a “0” by a second voltage level. The code signals Ca, Cb, Cn can have a unit interval, or minimum time interval between signal transitions, and the length in time of the code signal's sequence can be referred to herein as the duration of the code signal. In one example, the code signals Ca, Cb, Cn are generated using impulses filtered through a match filter. For example, a code can contain 64 impulses that have been filtered through a match filter. The number of impulses in a code can be referred to as the length of the code signal. Continuing in this example, the length of this code signal is 64.

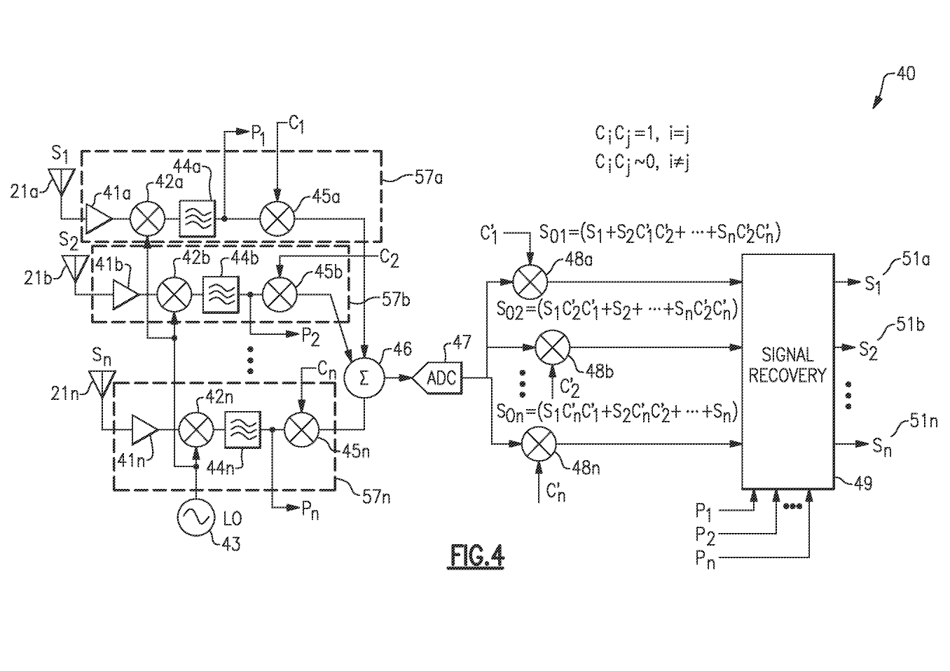

The code signals Ca, Cb, Cn can be used to encode the received analog signals from antennas 21a, 21b, 21n. In one embodiment, the code signals Ca, Cb, Cn are implemented using a binary Walsh code. However, other configurations are possible. For example, in another embodiment, the code signals Ca, Cb, Cn are generated using a random number generator that generates random or pseudo-random binary sequences. As will be described in detail further below with respect to FIG. 4, in certain configurations a code signal can be orthogonal to an anticode signal that is used for decoding. For example, the anticode signal may be used in decoding procedure after combining the coded analog signals at the shared ADC 47. Such a code with orthogonal properties can be referred to as an orthogonal code.

As shown in FIG. 3, each received analog signal is encoded in the analog domain at the respective receiver front end 37a, 37b, 37n, and then combined into a combined analog signal using the adder 46. The combined analog signal is converted into a combined digital signal 39 (S) using the shared ADC 47. In certain configurations, the combined analog signal is generated based on summing currents at a node, and the adder 46 represents the node used to sum the currents. Thus, the adder 46 need not be an explicit adder in certain embodiments. For example, in one embodiment, the adder 46 is a single node. Many other well-known techniques are possible to implement the addition function of the adder 46.

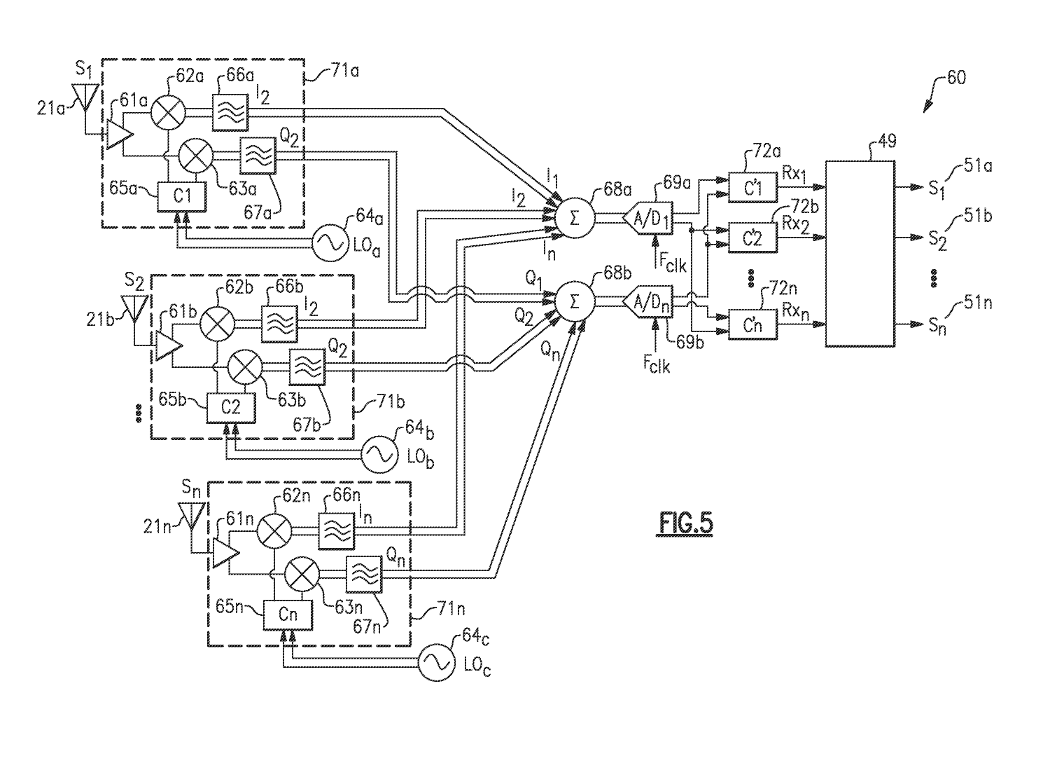

Although FIG. 3 illustrates an embodiment using a single shared ADC 47, other configurations are possible. For example, in another embodiment described below with reference to FIG. 5, a scalable receiver operates using quadrature receiver front ends for each antenna, and the scalable receiver includes a first shared ADC for processing a combined in-phase (I) signal and a second shared ADC for processing a combined quadrature-phase (Q) signal.

The digital output signal S 39 from the shared ADC 47 can be transmitted to various digital signal processing circuitry (not illustrated in FIG. 3) for further processing. For example, the combined digital signal S 39 can be transmitted to a signal recovery system for recovery and/or estimation of the analog signals received at antennas 21a, 21b, 21n. As will be further described with reference to FIGS. 4-7, various signal recovery systems can be used to process the combined digital signal 39 generated by the shared ADC 47.

As depicted in FIG. 3, each signal received over the antennas 21a, 21b, 21n has an independent receiver channel. For example, the received analog signal from antenna 21a has an independent receiver channel with receiver front end 37a that receives a corresponding code signal Ca. As will be described in further detail below, FIGS. 4-7 present various descriptions of other embodiments of receiver channels having an RF front end.

Although FIG. 3 illustrates a scalable receiver, circuitry used for transmit operations can be added to provide both transmit and receive functionality. Accordingly, the teachings herein are applicable to both receiver and transceiver communications systems.

FIG. 4 is a schematic diagram of one embodiment of a scalable receiver 40. The scalable receiver 40 includes antennas 21a, 21b, 21n, receiver front ends 57a, 57b, 57n, a local oscillator 43, an adder 46, a shared ADC 47, decoding mixers 48a, 48b, 48n, and a signal recovery block 49. As shown in FIG. 4, receiver front ends 57a, 57b, 57n include LNAs 41a, 41b, 41n, down-conversion mixers 42a, 42b, 42n, filters 44a, 44b, 44n, encoding mixers 45a, 45b, 45n, respectively. The scalable receiver 40 provides scalability for 4.5G and/or 5G communications, including for MIMO and/or multi-band configurations. However, the scalable receiver 40 can also be used for other communications and/or applications.

Although illustrated for the case of processing n=3 RF signals, the receiver 40 can be scaled to process additional RF signals. In certain configurations, the scalability of the scalable receiver 40 can depend on the length of codes and the number of antennas within the scalable receiver 40. For example, if the number of antennas is represented as M; and the length of a code signal is represented as N, the scalable receiver 40 can be fully calibrated when N<=M. As will be described below, calibration can reduce the error (e.g., loss) when coding.

In the illustrated embodiment, an RF front end is used to process each signal received over the antennas 21a, 21b, 21n. For example, the first RF front end 57a includes the LNA 41a, the mixer 42a, the filter 44a, and the encoding mixer 45a processes a first RF signal received by the antenna 21a. Likewise RF front ends 57b, 57n associated with the LNAs 41b, 41n, the mixers 42b, 42n, the filters 44a, 44b, 44n, and the encoding mixers 45b, 45n are used to process RF signals received by the antennas 21b, 21n, respectively. Although one example implementation of RF front ends is shown, RF front ends can be implemented using a wide variety of configurations. In one example, the RF front ends can have an additional filter element after mixers 45a, 45b, 45n to filter out any noise introduced by the coding process. For instance, the code signals Cl, C2, and Cn may have noise introduced into the signals due to a prior conversion process of the code signals from a digital domain to an analog domain. The additional filter elements after mixers 45a, 45b, 45n can provide filtering for any frequency noise introduced in such a conversion process.

LNAs 41a, 41b, 41n can be implemented in a wide variety of ways to provides low noise amplification. An LNA can be used to reduce the overall noise figure (NF) of an RF front end.

In the illustrated embodiment, the down conversion mixers 42a, 42b, 42n can be used on each analog signal to convert that signal to a baseband frequency. Although an implementation using direct conversion in shown, in certain configurations down conversion mixers can be used to down-shift the frequency content of receive signals to an intermediate frequency.

With continuing reference to FIG. 4, by converting each signal to a baseband frequency and then encoding the down converted signal, the scalable receiver 40 can be used to increase the bandwidth of data transmitted over a communication system using scalable receiver 40. By down-converting and coding each analog signal, interfering frequencies (e.g., a blocking frequency adjacent to the frequency of interest) received by antennas 21a, 21b, 21n can be removed from the signal recovery and/or estimation process. Such a scalable receiver 40 with down conversion mixers 42a, 42b, 42n working in conjunction with encoding mixers 45a, 45b, 45n can thus mitigate some of the disadvantages of traditional communication systems, namely, the presence of interfering signals. In interfering signal can also be referred to as a blocker signal. For example, the RF front ends 57a, 57b, 57n, depicted in FIG. 4, can code the received analog signals that are coded and combined in the code domain. This approach allows representations of the received analog signals to be combined without the effects of blocking signals introduced into the code domain. Accordingly, the scalable receiver 40 can mitigate any interfering frequencies received by antennas 21a, 21b, 21n when such frequencies are introduced into the scalable receiver 40 during the down-conversion process (e.g., when mixing the LO 43 with the received analog signals at mixers 42a, 42b, and 42n).

The filters 44a, 44b, 44n can be used on each down-converted analog signal to generate a filtered analog signal. Filters 44a, 44b, 44n can be filter that passes or attenuates a particular band in a particular region of the baseband spectrum. To accomplish this, a variety of filters can be used such as a band-pass filter, a low-pass filter, or a high-pass filter. As an example, a band-pass filter can be centered at a frequency of interest (e.g., the frequency at which each antenna 21a, 21b, 21n is configured to receive the analog signal), and then pass frequencies within a certain band of that frequency (e.g., a center frequency). With such a filter, the effects of blocking frequencies, which may also be down-converted during the down-conversion process, may be mitigated as a blocking frequency can be “filtered out” or attenuated.

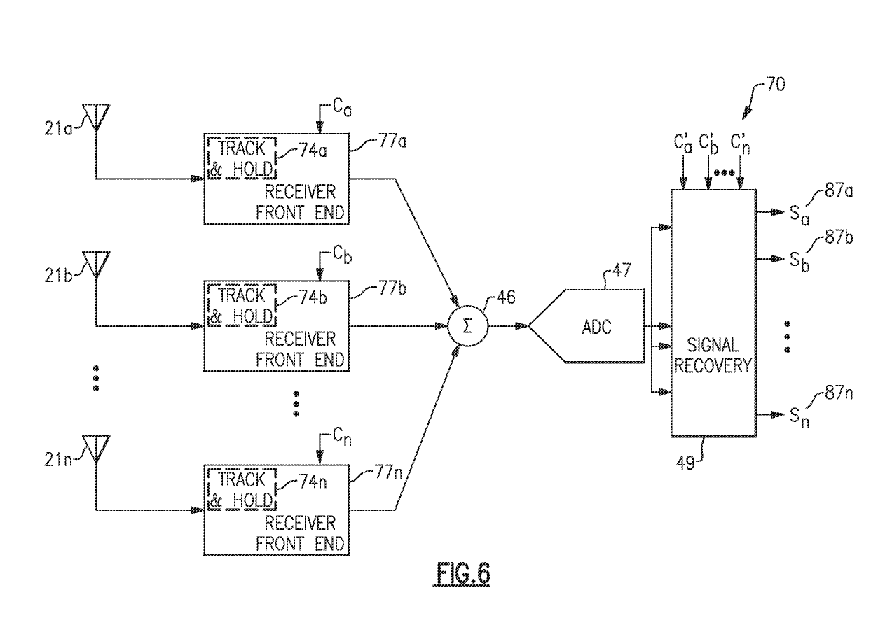

Additionally, continuing in the embodiment depicted in FIG. 4, with each received analog signal processed in an independent receiver channel, coding gain may not be a primary factor when coding the received analog signals for combination in the code domain. In traditional communication systems (e.g., CDMA), coding gain may be used at the transmitter side in anticipation of losses that will be experienced by the coded analog signals over a communication medium. For example, a CDMA wireless transmitter may increase the amplitude of an analog signal during coding by a 20 dB gain. Such a gain may be used to compensate for the fading and multipath losses experienced by the coded CDMA signal when transmitted over a wireless channel. In contrast to such a CDMA system, the system as described herein and with reference to FIG. 4, codes analog signals at the receiver side, and further, codes each in an independent receiver channel. Accordingly, because losses substantially similar to a wireless channel (or generally, a communications medium) are not present at scalable receiver 40, coding gain as high as 20 dB may not be a primary factor when coding the received analog signals from antennas 21a, 21b, 21n. From another viewpoint, each received analog signal is coded with a code of length N. In contrast, a traditional CDMA system may code M analog signals together with a code of length N*M. As can be seen, not only does scalable receiver 40 require less processing power (e.g., coding gain), signals coded in scalable receiver may be processed more efficiently as the length of the codes can be shorter in length. In addition, as will be described with respect to FIG. 6 below, circuitry used as part of the coding process may not require high sampling rates, as a traditional communication system may require.

In the illustrated configuration, the encoding mixers 45a, 45b, 45n are used to encode the analog filtered signals generated by the filters 44a, 44b, 44n based on multiplying the analog filtered signals by the code signals C₁, C₂, Cₙ, respectively. Accordingly, each received signal Sᵢ (i=1, 2, . . . n) is encoded with a code signal Cᵢ. As described above with respect to FIG. 3, various codes are possible to be used by a scalable receiver. For example, the code signals C₁, C₂, . . . Cₙ can be selected to be substantially orthogonal to one another, such that Cᵢ*Cⱼ =1 for i=j and substantially equal to zero otherwise. As another example, an orthogonal code can be used that is orthogonal to the anticode signal to be used after the analog-to-digital conversion, also described further below.

In various embodiments, the code signals C₁, C₂, Cₙ may include a calibration aspect. For example the code signal C₁ can be a composite a calibration signal (B₁) multiplied by an original code signal (Cᵢ₁. Accordingly, in one embodiment using linear algebra techniques, the code signal C₁ can be expressed as C₁=B₁Cᵢ₁, where Cᵢ₁ is the initial code signal before calibration. For example, a calibration signal B₁ can be used to account for the conversion of a digital code signal to an analog code signal.

As an illustrative example of this conversion, a digital circuit can convert a digital code signal to an analog code signal. However, the resulting analog code signal may not be substantially equivalent to the digital code signal. In such a case, various linear algebra techniques can be used to determine the calibration signal B₁. The calibration signal B₁ can be the matrix that satisfies C₁=B₁Cᵢ₁. Accordingly, continuing in the same example, Cᵢ₁ can be the digital code signal and B₁ can represent the calibration necessary to compensate for the conversion error to the analog domain, such that C₁ is an analog code signal substantially equivalent to the initial digital signal Cᵢ₁ after multiplication by calibration signal B₁. As can be seen from this description, code signals C₂, Cₙ can also have calibration signals B₂, Bₙ. Accordingly, the calibration signal can be expressed in matrix form as B=[B₁ B₂ . . . Bₙ].

Various other calibrations can exist and be incorporated into a calibration signal B₁. As but another example, the noise introduced by the receiver front end can be incorporated into the calibration signal B₁. That is, the various circuits in the RF front end may introduce other noises into the RF front end that can, in turn, introduce noise into the coding process at the encoding mixers 45a, 45b, 45n. In one embodiment, the local oscillator 43 can have noise associated with the generation of an LO signal. That noise may affect coding mixers 45a, 45b, 45n such that there is an effect to the code signal C₁. Again, using linear algebra techniques, if D₁ represents the LO noise, the code signal C₁ can be expressed using Equation 1 below.

C1=D₁⁻¹*B₁*Cₙ Equation 1

Accordingly, as can be seen from this iterative process, multiple noises can be taken into account by the scalable receiver 40 so that the received analog signal can be coded by a corresponding code signal, without noise from the RF front end or noise from a digital-to-analog conversion process. In some embodiments, the calibration signal B may be applied at the shared ADC, rather than as part of a combination of the code signal. That is, when the shared ADC combines the coded analog signals, the shared ADC can also apply the calibration B to compensate for the noise in the digital-to-analog conversion process of the code signals.

Although FIG. 4 illustrates a particular implementation of RF front ends, the RF front ends of the scalable receiver 40 can be implemented in a wide variety of ways. For example, other buffer amplifiers, filters, variable gain amplifiers, etc., may be added and/or the illustrated components can be modified or rearranged to achieve a desired performance for a particular application. Accordingly, the scalable receivers herein can be used in conjunction with a wide variety of RF front ends implementations without departing from the scope of the present disclosure.

Although FIG. 4 illustrates a particular implementation of encoding, other configurations are possible. For example, signals received by antennas can be encoded during down-conversion or in an intermediate frequency (IF) stage prior to combining As another example, the filters 44a, 44b, 44n can include an input for code signals such that the received analog signal is filtered and encoded at the same element. Or, as another example, filters 44a, 44b, 44n can include a code that is part of the filter, such that certain frequencies are modified by the filter to be “coded.” For example, in one embodiment, an analog signal passes through the filter such that an amplitude of a particular frequency is increased, representing an impulse function applied to that particular frequency.

The digital output signal generated by the shared ADC 47 corresponds to a digital representation of the combined analog signal. The digital output signal can be processed using digital circuitry to estimate RF signals S₁, S₂, Sₙ received by each of the antennas 21a, 21b, 21n.

For example, in the illustrated configuration, the decoding mixers 48a, 48b, 48n are used to provide n decoded signals to the signal recovery block 49 based on multiplying the digital output signal by the n anticode signals C′₁, C′₂, . . . C′ₙ. As used herein, C corresponds to the code signal input to encoding mixers 45a, 45b, 45n, C′ corresponds to the anticode signal input to decoding mixers 48a, 48b, 48n (e.g., also referred to as an anticode signal). As one example, C′ can be configured to be C⁻1. Configuring the code and anticode signals in this manner can enhance the accuracy of signals estimated using the signal recovery block 49. In one embodiment, the code signals on the decoder side can be referred to as the digital anticodes of the analog codes from the encoding side of the scalable receiver 40.

In certain configurations the decoding mixers 48a, 48b, 48n and/or the signal recovery block 49 are implemented using a digital signal processor (DSP). For example, a DSP can be used to separate processing gain and signal estimation algorithms, which can provide signal estimation in part using signal amplitudes P₁, P₂, . . . Pₙ in certain implementations. For example, the signal amplitudes P₁, P₂, . . . Pₙ can be Received Signal Strength Indicator (RSSI) measurements.

In the illustrated configuration, the digital output signal from the shared ADC 47 is applied to n output signal processing paths, where each path is again modulated with one of the n anticode signals, C′ᵢ The resulting output products Sₒᵢ are the initial estimates of each of the original signals Sᵢ received at the corresponding antenna.

The signal recovery block 49 iteratively improves on the n signal estimates 48 using known signal processing algorithms for interference cancellation, to produce the final outputs 51a,51b . . . 51n. For example, as described above, linear algebra techniques can be used to generate the final outputs 51a,51b . . . 51n, which are estimates of the initial analog signals received at antennas 21a, 21b, and 21n. For example, using linear algebra techniques, the signal recovery block can determine that estimated RF signal, Sₒᵢ=SᵢY CC′, where Sₒᵢ=[S₁ S₂ . . . Sₙ]. and Sᵢ is a vector of the received analog signals at antennas 21a, 21b, 21n.

Additionally, the signal estimation process can be used to obtain processing error, E. For example, the processing error E can be obtained by processing a known signal through the RF front end and the decoding process. Using a known signal, the difference between the known signal and resulting estimated signal can be referred to as the processing error, E. Accordingly, the code signals C₁, C₂, Cₙ at the receiver end can further include compensation for the processing error, such that C=CE′.

Additional details of the scalable receiver 40 can be similar to those described earlier.

In various embodiments not depicted, the signal recovery process can be performed on a computing device separate from the receiver front ends and analog circuitry of FIG. 4. For example, using the digital output signal generated by the shared ADC 47, the digital output signal can be processed on another computing device using signal processing techniques or a network computing device in a cloud computing environment. A computing device may generally include any computing device transmitting or receiving the digital output signal through a network (e.g., the public Internet or a private network). Computing devices may include end user devices, devices owned or operated by other service providers, or devices owned or operated by an administrator of (e.g., a data center operator) a data center. Other examples of computing devices include, but are not limited to, laptops, personal computers, tablet computers, personal digital assistants (PDAs), hybrid PDA/mobile phones, mobile phones, electronic book readers, digital media players, wearable computing devices, integrated components for inclusion in computing devices, appliances, electronic devices for inclusion in vehicles or machinery, gaming devices, set top boxes, electronic devices for inclusion in televisions, and the like.

FIG. 5 is a schematic diagram of another embodiment of a scalable receiver 60. The scalable receiver 60 includes antennas 21a, 21b, 21n that receive signals S1, S2, Sn, respectively. The scalable receiver 60 further includes LNAs 61a, 61b, 61n, in-phase down-conversion/coding mixers 62a, 62b, 62n, quadrature-phase down-conversion/coding mixers 63a, 63b, 63n, local oscillators 64a, 64b, 64n, mixer control circuits 65a, 65b, 65n, in-phase filters 66a, 66b, 66n, quadrature-phase filters 67a, 67b, 67n, an in-phase adder 68a, a quadrature-phase adder 68b, a shared in-phase ADC 69a, a shared quadrature-phase ADC 69b, decoding circuits 72a, 72b, 72n, and a signal recovery block 49 with complex signal outputs 51a, 51b, 51n.

The illustrated scalable receiver 60 operates using quadrature receiver front ends 71a, 71b, 71n for each antenna 21a, 21b, 21n. Accordingly, a quadrature receiver front end 71a for antenna 21a includes LNA 61a, in-phase down-conversion/coding mixer 62a, quadrature-phase down-conversion/coding mixer 63a, local oscillator 64a, mixer control circuit 65a, in-phase filter 66a, and quadrature-phase filter 67a. Although illustrated for the case of processing n=3 RF signals, the receiver 60 can be scaled to process additional RF signals.

In the illustrated configuration, each receiver is implemented using quadrature signaling. Additionally, the illustrated configuration combines coding and down-conversion operations. The teachings herein are applicable to configurations in which down-conversion and encoding are combined and to configurations in which down-conversion and encoding occurs separately.

LNAs 61a, 61b, 61n may operate substantially the same as LNAs 41a, 41b, 41n. A quadrature analog signal received from antennas 21a, 21b, 21n may be amplified to reduce the overall noise figure of the quadrature analog signal. After being amplified by LNAs 41a, 41b, 41n, the various quadrature analog signals can be coded with code signals C1, C2, Cn; and also down-converted to a baseband frequency at the respective mixers for the in-phase and quadrature components of the analog signal. Accordingly, in-phase down-conversion/coding mixers 62a, 62b, 62n and quadrature-phase down-conversion/coding mixers 63a, 63b, 63n mix and down-convert the amplified, received analog signals. The amplified, received analog signals are down-converted at the frequency of the signal oscillating at the respective local oscillators 64a, 64b, 64n. As depicted in FIG. 5, some embodiments of a quadrature analog signal may include two components for both the in-phase and quadrature portions of the quadrature analog signal. For example, an analog received signal can be expressed as an analog quadrature received signal by Equation 2 below:

sin[2πft+φ(t)]=sin[2πft]*cos[φ(t)]+cos[2πft]*sin[φ(t)] Equation 2

As persons having ordinary skill in the art will appreciate, the first term in Equation 2 corresponds to an in-phase component and the second term corresponds to a quadrature component. Accordingly, during down-conversion at in-phase down-conversion/coding mixers 62a, 62b, 62n and quadrature-phase down-conversion/coding mixers 63a, 63b, 63n, the quadrature analog signals can be separated into further frequency components for respective portions of both the in-phase component and the quadrature component. As depicted, this may result in two signals outputted for both the in-phase and quadrature portions of the quadrature analog signal.

Additionally, the mixer control circuits 64a, 65b, 65n can control various aspects of the coding or mixing process. For example, the mixer control circuits 64a, 65b, 65n can include various LC circuits that can alter the down-converting frequency of the respective local oscillators 64a, 64b, 64n. Or, as another example, the mixer control circuits 64a, 65b, 65n can alter the code signal C1, C2, Cn that codes the analog signals. For example, mixer control circuit can include various signal processing circuits configured to output impulse functions to generate particular code signals. Mixer control circuits 64a, 65b, 65n can alter the functioning of such signal processing circuits; and, in turn, alter the code signals.

Continuing with reference to FIG. 5, after mixing and down-converting, the coded, baseband analog signals are filtered at in-phase filters 66a, 66b, 66n and quadrature-phase filters 67a, 67b, 67n. For example, as described above with respect to FIG. 4 for filters 44a, 44b, 44n, the signals may be filtered in a substantially similar fashion. At the in-phase adder 68a and the quadrature-phase adder 68b, the in-phase components from the processed received signal are summed together, and the quadrature components of the processed received signal are summed together. For example, as described above with respect to FIG. 3 for adder 46, the respective signals may be summed together at the respective adders in a substantially similar fashion.

The scalable receiver 60 also includes a first shared ADC 69a for processing a combined in-phase (I) signal and a second shared ADC 69b for processing a combined quadrature-phase (Q) signal. As depicted, the first shared ADC 69a and the second shared ADC 69b may be driven by a common clock with a clock signal, F_{cLK}. The first shared ADC 69a can be configured to combine particular portions of the in-phase component. For example, if the in-phase components can be represented as sinusoidal functions, the first shared ADC 69a may be configured to combine the sinusoidal portions from the various in-phase signals input into the first shared ADC 69a and to combine the cosinusoidal portions similarly. Additionally, the second shared ADC 69b may be configured to combine the various portions of the quadrature-phase (Q) signal similarly.

With the respective combined signals from the first shared ADC 69a and the second shared ADC 69b, decoding circuits 72a, 72b, 72n can control various aspects of the decoding process. The decoding circuits 72a, 72b, 72n may work in conjunction with the mixer control circuits 64a, 65b, 65n to determine anticodes of the code signals C′1, C′2, C′n. The decoding circuits 72a, 72b, 72n can include various signal processing circuits configured to output impulse functions to generate particular anticode signals. The decoding circuits 72a, 72b, 72n can generate anticode signals that decode the code signals, for example, such anticode signals as those described with reference to FIG. 3.

Additional details of the scalable receiver 60 can be similar to those described earlier. For example, FIG. 5 also depicts a signal recovery block 49 of FIG. 4. Here, output signals S1, S2, Sn may be outputted by the signal recovery block, which may vary in estimation of the received analog signals, due to the different processing of the received analog signals as described herein with respect to FIG. 5.

FIG. 6 is a schematic diagram of one embodiment of a scalable receiver 70. The scalable receiver 70 includes antennas 21a, 21b, 21n, receiver front ends 77a, 77b, 77n that each include respective track and hold (track & hold) circuitry 74a, 74b, 74n and respective code signals Ca, Cb, Cn for coding of the received analog signals, adder 46, shared ADC 47, and a signal recovery circuit 49. The scalable receiver 70 provides scalability for 4.5G and/or 5G communications, including for MIMO and/or multi-band configurations. However, the scalable receiver 35 can also be used for other communications and/or applications. Details of the scalable receiver 70 with respect to can be similar to those described earlier.

Although illustrated for the case of processing n=3 RF signals, the receiver 70 can be scaled to process additional RF signals.

More specific to the embodiment depicted in FIG. 6, the receiver front ends 77a, 77b, 77n include respective track & hold circuitry 74a, 74b, 74n. Track & hold circuitry can also be referred to as sample and hold. In various embodiments, the track & hold circuitry 74a, 74b, 74n can be configured to “track” or “sample” portions of the analog signals received at antennas 21a, 21b, 21n. The track & hold circuitry 74a, 74b, 74n may sample portions of the analog signals at a rate associated with a common clock (not depicted). In various embodiments, such a common clock may be used by the shared ADC 47.

In one embodiment, any of the track & hold circuitry 74a, 74b, 74n can be an analog circuit that utilizes capacitors, in conjunction with one or more switches or field effect transistors, to store various values of the respective received analog signal. Various configurations of the circuitry of track &hold circuitry 74a, 74b, 74n may accomplish such storing of values, or any of the other aspects or functionalities of the track &hold circuitry 74a, 74b, 74n described herein. For example, a sampling circuit may sample certain values of the received analog signals and hold those values for a specified time period, as governed by the common clock. For example, the sampling circuit may capture a voltage of a continuously varying analog signal and holds the voltage at that level for a period of time (e.g., storing the voltage in a capacitor). Such a sampling circuit may utilize capacitors and amplifiers (e.g., an operation amplifier), in conjunction with one or more switches or field effect transistors, to store various values of the respective received analog signal.

Including the track & hold circuitry 74a, 74b, 74n in the receiver front ends 77a, 77b, 77n can enhance the ability of the scalable receiver 70 to separate the digital output signal of the ADC 47 into separate digital signals associated with each receiver channel. For example, sampling and holding an analog receive signal for an amount of time greater than or equal to a code signal's duration can provide substantially perfect code separation, thereby allowing received signals to be fully recovered rather than estimated.

In utilizing the track & hold circuitry 74a, 74b, 74n, the scalable receiver 70 may achieve lower sampling rates than the sampling rate at shared ADC 47. In turn, in various embodiments, this may lead to lower coding rates of the code signals Ca, Cb, Cn. Accordingly such a scalable receiver 70 may mitigate some of the issues present in high coding rates of traditional communication system coding. For example, in a CDMA transmitter, analog signals may up-converted from baseband, but, at the same, may use a single large code signal for coding all of those up-converted analog signals as an aggregate. A CDMA transmitter may code analog signals at the transmitter side, rather than the approach taken in the scalable receivers described herein, which codes analog signals at a receiver end.

Accordingly, coding several up-converted analog signals as an aggregated large analog signal may require a higher coding rate for encoding. In contrast, with the approach taken by the architecture of scalable receiver 70, several analog receive signals can be down-converted in a respective receiver front end 77a, 77b, 77n. And such analog signals can also be coded at lower coding rates in the various RF front ends of scalable receiver 70. For example, if the sampling rate of the shared ADC 47 is X MHz, then each of the track & hold circuitry 74a, 74b, 74n may have a sampling rate corresponding to X MHz/N, where N is the number of antennas in the scalable receiver 70. Accordingly, the scalable receiver 70 may be configured for low coding rates, in part, due to the lower sampling rates in each of the various receiver front ends 77a, 77b, 77n with the respective track & hold circuitry 74a, 74b, 74n.

Additional details of the scalable receiver 70 can be similar to those described earlier. As an example, FIG. 4 depicts a signal estimation block 49. Signal recovery block 49 may be configured to operate in a similar fashion. Here, output signals S1 87a, S2 87b, Sn 87n may be outputted by the signal recovery block 49, which may vary in recovery or estimation of the received analog signals, due to the different processing of the received analog signals as described herein with respect to FIG. 6.

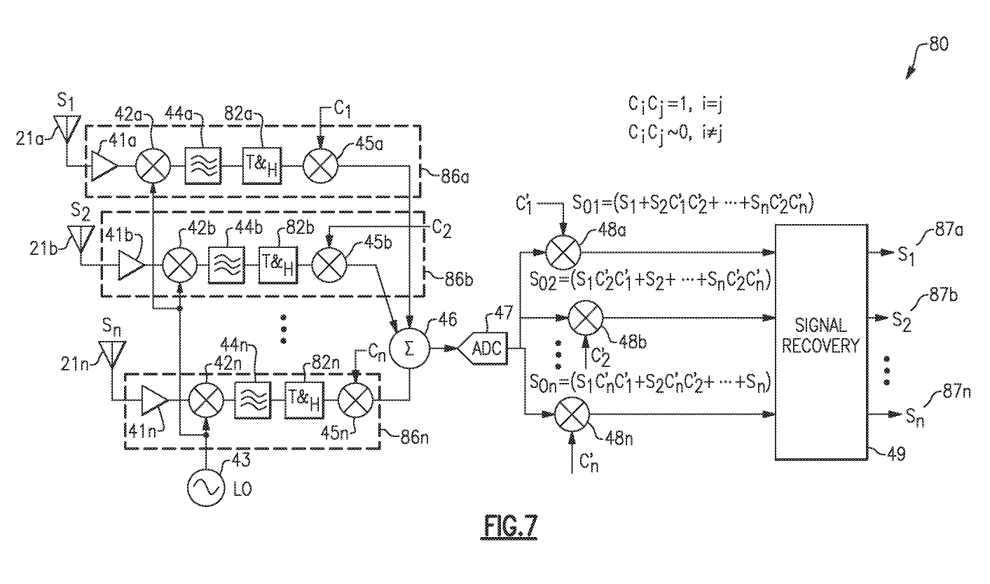

FIG. 7 is a schematic diagram of another embodiment of a scalable receiver 80. The scalable receiver 80 includes antennas 21a, 21b, 21n, receiver front ends 86a, 86b, 86n, a local oscillator 43, an adder 46, a shared ADC 47, decoding mixers 48a, 48b, 48n, and a signal recovery block 49. As shown in FIG. 7, receiver front ends 86a, 86b, 86n include LNAs 41a, 41b, 41n, down-conversion mixers 42a, 42b, 42n, filters 44a, 44b, 44n, track & hold circuitry 82a, 82b, 82n, encoding mixers 45a, 45b, 45n, respectively. The scalable receiver 80 provides scalability for 4.5G and/or 5G communications, including for MIMO and/or multi-band configurations. However, the scalable receiver 80 can also be used for other communications and/or applications. Although illustrated for the case of processing n=3 RF signals, the receiver 40 can be scaled to process additional RF signals.

Details of the scalable receiver 70 can be similar to those described earlier, for example, for any of the illustrated components having the same denoted numerical indicator as those in FIG. 4. As an example, FIG. 4 depicts a signal estimation block 49. Signal recovery block 49 may be configured to operate in a similar fashion. Here, output signals S1 87a, S2 87b, Sn 87n may be outputted by the signal recovery block 49, which may vary in recovery or estimation of the received analog signals, due to the different processing of the received analog signals as described herein with respect to FIG. 7.

Additionally, FIG. 7 depicts track & hold circuitry 82a, 82b, 82n within the receiver front ends (depicted with dotted lines). Such track & hold circuitry 82a, 82b, 82n may operate in a similar fashion as the track & hold circuitry 74a, 74b, 74n described with respect to FIG. 7 above. In other embodiments, not depicted, the track & hold circuitry 82a, 82b, 82n can be configured to operate before the respective filters 44a, 44b, 44n. Various configurations are possible. As another example, the track & hold circuitry 82a, 82b, 82n may be configured to operate outside of the receiver front end as a separate component immediately after antennas 21a, 21b, 21n.

The scalable receivers herein can provide numerous advantages over other receiver architectures, such as those using conventional CDMA. For example, in a conventional CDMA receiver, encoded signals can share the same spectrum. However, conventional CDMA suffers from a reduction in signal-to-noise ratio (SNR) as the number of encoded signals sharing the same spectrum increases. Additionally, a conventional CMDA receiver is limited by each received signal originating from a separate signal source, such as a cellular handset. Hence, each signal finds its own propagation path to the receiver. Multi-path and propagation delays in a conventional CDMA receiver render further signal estimation difficult or impossible.

In contrast, the teachings herein can operate without multi-path effects. For example, received signals are encoded in the IF of the radio and hence multi-path effects are not imposed on the encoded signals.

Furthermore, the amplitude of signals can be determined in the scalable receivers herein. The amplitude information can aid in signal estimation and/or in implementation a receive strength indicator (RSSI) on each receiver path. In contrast, it can be difficult to determine amplitude information in a conventional CDMA receiver, since the desired signals can be corrupted by multipath effects, delay spreading, propagation losses, and/or fading.

The teachings herein can be combined with iterative approaches to beam forming, which can be facilitated by massive receiver architectures in which a large amount of scaling is used. Iterative approaches to beam forming can further enhance amplitude differences between the various interfering signals, making optimal detection more likely.

The signal recovery blocks herein can estimate the received signals using a variety of algorithms of varying complexity. In certain configurations, an iterative sequence detection algorithm, such as maximum likelihood sequenced detection or minimum probability of error detection can be used together with beam steering and/or signal power information to provide signal estimation. Although the teachings herein are not limited to any particular signal estimation algorithm, the scalable receiver architectures herein makes an iterative sequence detection algorithm more performing and scalable relative to when such an algorithm is used in a conventional architecture.

### Applications

Devices employing the above described schemes can be implemented into various electronic devices. Examples of the electronic devices can include, but are not limited to, consumer electronic products, parts of the consumer electronic products, etc. Examples of the electronic devices can also include circuits of radio frequency systems, including, for example, mobile devices, and cellular radio base stations, including those operating at radio frequencies and/or microwaves frequencies.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well. Accordingly, the scope of the present invention is defined only by reference to the appended claims.

What is claimed is:

1. An apparatus comprising:
a plurality of receiver channels comprising:
a first receiver channel configured to receive a first analog receive signal, wherein the first receiver channel comprises a first receiver front end configured to generate a first coded analog signal based on coding the first analog receive signal with a first code signal; and
a second receiver channel configured to receive a second analog receive signal, wherein the second receiver channel comprises a second receiver front end configured to generate a second coded analog signal based on coding the second analog receive signal with a second code signal; and
an analog-to-digital converter (ADC) configured to combine at least the first and second coded analog signals to generate a digital output signal.

2. The apparatus of claim 1,
wherein the first receiver front end comprises a first track and hold circuit electrically connected in signal path through the first receiver front end; and
wherein the second receiver front end comprises a second track and hold circuit electrically connected in signal path through the second receiver front end.

3. The apparatus of claim 2, wherein the first receiver channel is configured to generate the first coded analog signal based on coding an output signal of the first track and hold circuit with the first code signal.

4. The apparatus of claim 1, wherein the first track and hold circuit is configured to hold an input signal for an amount of time greater than or equal to a duration of the first code signal.

5. The apparatus of claim 1, wherein the first code signal is orthogonal to the second code signal.

6. The apparatus of claim 1, wherein the first and second code signal are implemented in a Walsh code.

7. The apparatus of claim 1, wherein the first coded analog signal includes a radio frequency signal associated with a first frequency band, and wherein the second coded analog signal includes another radio frequency signal associated with a second frequency band, the second frequency band different than the first frequency band.

8. The apparatus of claim 1 further comprising:
a signal recovery system configured to receive the digital output signal from the ADC, wherein the signal recovery system is further configured to generate a digital representation of the first analog receive signal based on decoding the digital output signal with a first anticode signal, and wherein the signal recovery system is further configured to generate a digital representation of the second analog receive signal based on decoding the digital output signal with a second anticode signal.

9. The apparatus of claim 8, wherein the first anticode signal is related to the first code signal via a first inverse relationship, and wherein the second anticode signal is related to the second code signal via a second inverse relationship.

10. The apparatus of claim 1, wherein the plurality of receiver channels further comprises a third receiver channel configured to receive a third analog receive signal, wherein the third receiver channel comprises a third receiver front end configured to generate a third coded analog signal based on coding the third analog receive signal with a third code signal.

11. The apparatus of claim 1, further comprising a first antenna configured to generate the first analog receive signal and a second antenna configured to generate the second analog receive signal.

12. An apparatus comprising:
a plurality of antennas comprising a first antenna and a second antenna;
a plurality of receiver front ends comprising:
a first receiver front end including an input electrically connected to the first antenna and an output that generates a first coded analog signal, wherein the first receiver front end comprises a first track and hold circuit electrically connected in a signal path between the input and the output of the first receiver front end; and
a second receiver front end including an input electrically connected to the second antenna and an output that generates a second coded analog signal, wherein the second receiver front end comprises a second track and hold circuit electrically connected in a signal path between the input and the output of the second receiver front end; and
an analog-to-digital converter (ADC) configured to combine a plurality of coded analog signals including the first coded analog signal and the second coded analog signal.

13. The apparatus of claim 12, wherein the ADC comprises a wideband ADC.

14. The apparatus of claim 12,
wherein the first receiver front end comprises a first mixer configured to generate the first coded analog signal based on mixing an output of the first track and hold circuit with a first code signal; and
wherein the second receiver front end comprises a second mixer configured to generate the second coded analog signal based on mixing an output of the second track and hold circuit with a second code signal.

15. The apparatus of claim 14,
wherein the first receiver front end further comprises a first down conversion mixer electrically connected in a signal path between the input of the first receiver front end and an input of the first track and hold circuit, and
wherein the second receiver front end further comprises a second down conversion mixer electrically connected in a signal path between the input of the second receiver front end and an input of the second track and hold circuit.

16. The apparatus of claim 14, wherein the first code signal and the second code signal are orthogonal to each other.

17. A method of radio frequency communication, the method comprising:
receiving a first analog receive signal from a first antenna;
generating a first coded analog signal based on coding the first analog receive signal with a first code signal using a first receiver front end;
receiving a second analog receive signal from a second antenna;
generating a second coded analog signal based on coding the second analog receive signal with a second code signal using a second receiver front end;
generating a combined analog signal based on combining at least the first and second analog receive signals; and
converting the combined analog signal to a digital output signal using a shared analog-to-digital converter (ADC).

18. The method of claim 17, further comprising:
generating a digital representation of the first analog receive signal based on decoding the digital output signal using a first anticode signal; and
generating a digital representation of the second analog receive signal based on decoding the digital output signal using a second anticode signal.

19. The method of claim 17, further comprising:
processing the first analog receive signal in the first receiver front end to generate a first processed signal;
sampling the first processed signal using a first sampling circuit of the first receiver front end;
processing the second analog receive signal in the second receiver front end to generate a second processed signal; and
sampling the second processed signal using a second sampling circuit of the second receiver front end.

20. The method of claim 19,
wherein generating the first coded analog signal comprises mixing the first code signal with an output of the first track and hold circuit, and
wherein generating the second coded analog signal comprises mixing the second code signal with an output of the second track and hold circuit.
